(19) United States
(12) Patent Application Publication
(10) Pub. No.: US 2024/0368743 A1
(43) Pub. Date: Nov. 7, 2024

(54) Copper alloy composition and method for manufacturing same, method for manufacturing a part from the copper alloy composition

(71) Applicant: THALES, COURBEVOIE (FR)

(72) Inventors: Pierre ELOI, VALENCE CEDEX (FR); Melek GENC, VALENCE CEDEX (FR)

(21) Appl. No.: 18/689,425

(22) PCT Filed: Sep. 13, 2022
(86) PCT No.: PCT/EP2022/075438

§ 371 Date: Mar. 6, 2024

(30) Foreign Application Priority Data
Sep. 15, 2021 (FR) FR2109686

(51) Int. Cl. C22C 32/00; B22F 10/28; B33Y 10/00; B33Y 70/00; C22C 1/10

(52) U.S. Cl. CPC C22C 32/0036; B22F 10/28; B33Y 10/00; B33Y 70/00; C22C 1/1042; C22C 1/1084; B22F 2301/10; B22F 2302/253; B22F 2303/01; B22F 2303/05

(57) ABSTRACT

The copper alloy composition is a Cu_{comp}(Al₂O₃)ₐZr_{b}Cr_{c} mass composition in which, in mass percent 1.5%≤a≤5%, 0.01%≤b≤5%, 0%≤c≤5%, the complement consisting of copper and unavoidable impurities.

### CROSS-REFERENCE TO RELATED APPLICATIONS

This application claims benefit under 35 USC § 371 of PCT Application No. PCT/EP2022/075438 entitled COPPER ALLOY COMPOSITION AND METHOD FOR MANUFACTURING SAME, METHOD FOR MANUFACTURING A PART FROM THE COPPER ALLOY COMPOSITION, filed on Sep. 13, 2022 by inventors Pierre Eloi and Melek Genc. PCT Application No. PCT/EP2022/075438 claims priority of French Patent Application No. 21 09686, filed on Sep. 15, 2021.

### FIELD OF THE INVENTION

The present invention relates to the field of copper alloy compositions, in particular for the manufacture of mechanical parts subjected to major environmental stresses (high temperature, heat cycles, various environmental impacts).

Said environmental stresses are encountered for example in the field of aeronautics but also in the space sector, automotive industry or in any other sector.

### BACKGROUND OF THE INVENTION

Additive manufacturing is a process involving layer-by-layer construction or manufacture via additions of material, as opposed to the removal of material in conventional machining. Methods of additive manufacturing include but are not limited to Selective Laser Melting (SLM), Selective Laser Sintering (SLS) and Direct Metal Deposition (DMD).

Additive manufacturing allows the obtaining of parts of complex shapes with increased mass and the possibility of adding new functionalities.

At the current time, the use of copper alloys in additive manufacturing methods by laser beam is hampered by the high reflectivity of copper which requires the use of high-powered laser beams for implementation of additive manufacturing by laser beam.

The properties of copper alloys are such that the energy provided by the laser beam is largely reflected rather than being absorbed. The mechanical strength of parts in copper alloy manufactured by additive manufacturing is deteriorated through the presence of defects (porosities, non-melt) possibly leading over the long term to early rupture of the parts.

It is possible to form structurally hardened copper alloys to obtain mechanical parts having satisfactory mechanical properties, for example by reinforcing the copper with a fine dispersion of aluminium oxide or alumina (Al₂O₃) known to be stable at high temperature. The particles of aluminium oxide block dislocations preventing grain growth whilst maintaining strong resistance of the copper alloy to high temperatures.

However, these copper alloys are not adapted to the solidification conditions of additive manufacturing methods. The mechanical properties of the parts obtained are inferior to those obtained with the same copper alloy but produced by conventional manufacturing methods.

### SUMMARY OF THE DESCRIPTION

It is one of the objectives of the invention to propose a copper alloy composition which allows the manufacture of parts having satisfactory mechanical properties, including by additive manufacturing.

For this purpose, the invention proposes a copper alloy composition of Cu_{comp}(Al₂O₃)ₐZr_{b}Cr_{b} mass composition in which, in mass percent: 1.5%≤a≤5%, 0.01%≤b≤5%, 0%%≤c≤5%, the complement consisting of copper and unavoidable impurities.

The alloy composition is in the form of a powder for example, or it is in solid form in particular in wire or plate form.

The invention also proposes a method for manufacturing a copper alloy composition such as defined above, the method comprising the steps of:
providing one or more precursor materials comprising copper, alumina, zirconium and optionally chromium;
combining the precursor materials to form the alloy composition.

According to particular embodiments, the method for manufacturing a copper alloy composition comprises one or more of the following optional characteristics, taken alone or in any technical possible combinations:
the precursor materials are provided in the form of alloy precursor powders, and the combining step comprises mechanical mixing of the alloy precursor powders to obtain the copper alloy composition in the form of a powder;
the alloy precursor powders each have a particle size of between 1 μm and 100 μm;
the precursor materials are provided in the form of solids, the combining step of the precursor materials comprising grinding of said solids;
the combining step of the precursor materials comprises a step to melt a mixture of the precursor materials, and a step under neutral gas to atomize the molten mixture into powder particles to obtain the copper alloy composition in powder form

The invention also proposes a method for manufacturing a part in copper alloy via additive manufacturing using a copper alloy composition such as defined above.

According to particular embodiments, the manufacturing method of a part in copper alloy comprises one or more of the following optional characteristics, taken alone or in any technical possible combinations:
the copper alloy composition is in the form of a powder and additive manufacturing is performed by melting or sintering particles of the copper alloy composition in powder form, by means of a high energy density beam in particular a high energy density laser beam;
additive manufacturing comprises the application, on the copper alloy composition, of at least one additive manufacturing technique chosen from among the direct metal deposition technique, selective laser melting technique, selective laser sintering technique, electron beam melting;
the method for manufacturing a part in copper alloy comprises the providing of the copper alloy composition in powder form, and performing of the following succession of steps (b) to (d):
(b) heating, by means of a high energy density beam, one portion of the copper alloy composition in powder form,
(c) withdrawing the high energy density beam from the portion of copper alloy composition,
(d) cooling the portion of copper alloy composition;
the method for manufacturing a part in copper alloy further comprises, before step (b), a step (a) to deposit a layer of the copper alloy composition in powder form on a substrate, and in that the heating step (b) of the portion of alloy composition in powder form is implemented by directing the high energy density beam onto a region of the deposited layer of copper alloy composition in powder form, the region forming said portion of copper alloy composition in powder form;
cooling of the portion of copper alloy composition takes place subsequent to step (c) to withdraw the high energy density beam;
steps (b) to (d) are implemented in a heated enclosed chamber and/or under a protective atmosphere of inert gas, argon in particular, the mass percentage of oxygen in said atmosphere being lower than 10,000 ppm;
the step to provide the alloy powder comprises implementation of the method for manufacturing a copper alloy composition such as defined above;
additive manufacturing comprises the use of a deposit of material in solid form from the copper alloy composition in solid form, in particular via Wire-Arc Additive Manufacturing.

The invention further proposes a part in copper alloy obtained with the manufacturing method such as defined above, said copper alloy having the mass composition Cu_{comp}(Al₂O₃)ₐZr_{b}Cr_{c} in which, in mass percent: 1.5%≤a≤5%, 0.01%≤b≤5%, 0%≤c≤5%, the complement consisting of copper and unavoidable impurities.

### BRIEF DESCRIPTION OF THE DRAWINGS

The invention and the advantages thereof will be better understood in the light of the examples of embodiment of the invention which are described below with reference to the appended drawings in which:

FIG. 1 is a schematic view of an atomization device for implementing a method for manufacturing a copper alloy powder according to one embodiment; and

FIG. 2 is a schematic view of an additive manufacturing device for the additive manufacturing of a mechanical part.

### DETAILED DESCRIPTION OF EMBODIMENTS

The copper alloy composition of the invention has a mass composition Cu_{comp}(Al₂O₃)ₐZr_{b}Cr_{c} in which, in mass percent: 1.5%<a≤5%, 0.01%≤b≤5%, 0%≤c≤5%, the complement (comp) consisting of copper and unavoidable impurities.

Aluminium oxide or alumina (Al₂O₃) generates precipitates which act as low energy nucleation sites promoting an increase in copper seeds on solidification of the copper alloy.

In an additive manufacturing process, in particular with Selective Laser Melting (SLM), speeds of solidification are high and the presence of aluminium oxide in a weight content higher than 1.5% allows the obtaining of a sufficiently high number of germinating precipitates so that the rapid movement of the solidification front does not precede the formation of new grains.

The addition of aluminium oxide or alumina (Al₂O₃) therefore allows limiting of grain size in the crystallographic structure of the copper alloy, which allows the desired mechanical properties of the copper alloy to be obtained, and in particular the obtaining of sufficient hardness of the copper alloy.

The addition of aluminium oxide also improves the stability of the copper alloy at high temperature, in particular above 600° C.

Zirconium (Zr) forms thermally stable dispersoids which have the effect of anchoring grain boundaries (called Zener Pinning effect) and hence of refining grain size whilst increasing the mechanical properties of the copper alloy. Zirconium does not have good resistance to high temperature, but the inventors have identified that the addition thereof in the copper alloy nevertheless allows an improvement in the anti-recrystallizing property of the aluminium oxide.

The addition of zirconium (Zr) allows a reduction in the minimum amount of aluminium oxide required to limit grain size. If very little zirconium is added, then the amount of aluminium oxide must be increased.

Zirconium acts as a heterogeneous element which leads to the formation of a finer distribution of aluminium oxide, and limits the coalescence mechanisms of aluminium oxide.

The presence of zirconium therefore allows a reduction in the amount of aluminium oxide needed to refine grain size.

The possible addition of chromium (Cr) allows the formation of hardening precipitates which maximize the mechanical properties of the copper alloy at ambient temperature i.e. in the region of 20° C.

The optional addition of chromium also allows limiting of the amount of aluminium oxide required to refine grain size.

Over and above a weight content of 5% aluminium oxide, a weight content of 5% zirconium and/or a weight content of 5% chromium, the thermal conductivity of the copper alloy is too strongly reduced, which is not desirable.

Preferably, the copper alloy composition is in the form of a powder or solid, in particular in wire or plate form.

Preferably, when the copper alloy composition is in powder form, this copper alloy powder has a particle size of less than 150 μm, for example less than 100 μm, and generally greater than one micron.

The copper alloy composition is manufactured for example from several precursor materials containing copper, aluminium oxide, zirconium and optionally chromium

The method for preparing the copper alloy composition comprises for example:
a step to provide precursor materials, and
a step to combine the precursor materials to form the copper alloy composition.

The contents of the different precursor materials are chosen as a function of the desired end composition of the copper alloy composition, evidently taking into consideration the dilution effect resulting from mixing of the precursor materials.

The precursor materials are provided for example in the form of several powders, hereafter called alloy precursor powders.

As a variant, the precursor materials are provided in the form of solids which are then ground to powder form.

The method for preparing the alloy powder therefore comprises:
a step to provide alloy precursor powders comprising copper, aluminium oxide, zirconium and optionally chromium, and
a step to combine the alloy precursor powders.

The contents of the different elements of the precursor powder are chosen as a function of the desired end composition of the alloy powder.

In a first embodiment, the alloy precursor powders are combined via mechanical mixing, to obtain a homogenous alloy powder having a particle size between 1 μm and 100 μm. Mechanical mixing is performed for example via grinding and mixing.

In a second embodiment, the alloy precursor powders are combined in a crucible and then atomized, preferably in a neutral gas atmosphere.

In this embodiment, the precursor materials are provided for example in the form of a powder or pre-alloyed bars.

In this embodiment, the combining step of the precursor materials comprises for example:
a step to melt the precursor materials until a homogenous bath of the chemical composition is obtained;
a step to atomize the molten mixture under neutral gas to obtain powder particles of particle size less than 150 μm.

At this atomization step, the molten material is sprayed in fine droplets by means of a gas jet under high pressure. The droplets solidify to form particles of copper alloy powder.

The gas jet is a jet of neutral gas for example, e.g. nitrogen, helium, argon or a mixture of several of these gases.

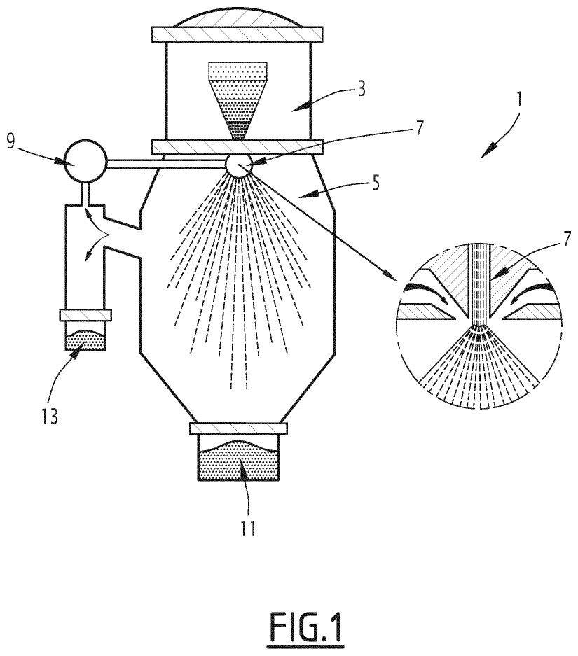

FIG. 1 as an example illustrates a gas atomization device 1.

This gas atomization device 1 comprises a melt chamber or autoclave 3, which is charged with the alloy elements that are melted therein to produce a molten mixture, under cover of air or a neutral gas, or else under a vacuum.

The gas atomization device 1 also comprises an atomization chamber 5, an atomization nozzle 7 and a gas source 9.

The atomization nozzle 7 is able to spray the molten mixture providing from the melt chamber 3 in the form of fine droplets into the atomization chamber 5 by means of a jet of gas under high pressure supplied by the gas source 9.

The atomization chamber 5, in the lower portion thereof, comprises a collection chamber 11 in which the particles of copper alloy powder are collected that result from solidification of the droplets.

The gas source 9 is preferably provided with a pump (not illustrated) able to collect the gas injected into the chamber for reinjection thereof via the atomization nozzle 7. The atomization chamber 5 also comprises an auxiliary collection chamber 13 intended to collect the powder particles entrained by the pump at the time of gas collection.

The copper alloy powder of the invention is used to manufacture parts via additive manufacturing, by melting or sintering the particles of copper alloy powder using a high energy beam.

The high energy beam can be a high energy density laser beam for example delivering a specific power in the region of 10⁵ W/cm².

The additive manufacturing method uses a powder bed laser selective melting or sintering technique for example, or a laser direct metal deposition technique.

The implementation of the manufacturing method with these techniques in all cases comprises a step to provide a copper alloy powder, and performing of the following successive steps (b) to (d):
(b) heating a region of the powder to a temperature which can be higher or lower than the melting point of the copper alloy powder, by means of a high energy density beam,
(c) withdrawing the high energy density beam from said region of copper alloy powder
(d) cooling said region of copper alloy powder at a cooling rate greater than or equal to 104° C./s.

The cooling at step (d) of the alloy powder region takes place for example as a result of withdrawal of the high energy density beam at step (c).

At step (d), the heated region of copper alloy powder solidifies to form one layer of the part.

Steps (b) to (d) can again be implemented iteratively to form successive layers of the part.

Selective Laser Melting (SLM) is an additive manufacturing method allowing the production of parts from a copper alloy powder by selectively melting i.e. locally, a region of an alloy powder layer deposited on a substrate.

Selective Laser Sintering (SLS) essentially differs from selective laser melting in that the region of the layer of copper alloy powder is not brought to a temperature higher than the melting temperature, but it is sintered.

The implementation of the manufacturing method by selective laser sintering or melting further comprises, before step (b) or before each step (b), a step (a) to deposit a layer of the alloy powder on a substrate.

The substrate is a build plate for example, or a layer of previously deposited or sprayed powder forming the part.

At step (a), the layer of copper alloy powder is therefore deposited for example on a build plate or on a layer of the part that has been previously produced by implementing steps (a) to (d).

At step (b), the laser beam is directed onto a region of the layer of deposited copper alloy powder. The powder region mentioned with reference to steps (b) and (d) therefore corresponds to the region of the powder layer onto which the laser beam is directed.

With the selective laser melting technique, at step (b), the region of the layer of copper alloy powder is brought to a temperature higher than the melting point of this alloy powder, to form a molten region.

With the selective laser sintering technique, at step (b), the region of the layer of copper alloy powder is not brought to a temperature higher than the melting point but it is sintered.

The shape of the region onto which the laser beam is directed, which is not necessarily convex, corresponds to one layer of the manufactured part.

Solely this region is heated, selectively, by the laser beam. The powder layer deposited at step (a) therefore comprises a molten or sintered region, and one or more powder regions that are non-molten and non-sintered.

At step (d), the molten or sintered region solidifies, thereby forming one layer of the part.

Steps (a) to (d) can again be implemented iteratively to form successive or adjacent layers of the part.

For example, at each step (a), each new layer of copper alloy powder can be deposited on the powder layer deposited at the preceding iteration or away from this preceding layer.

The excess copper alloy powder, corresponding to the non-molten portions of the layer of copper alloy powder, can be recovered either on completion of the manufacturing process or after each succession of steps (a) to (d), or after only some of the successions of steps (a) to (d).

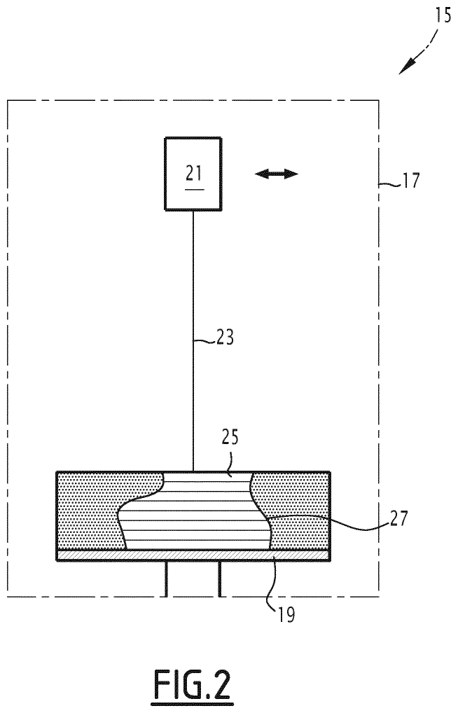

As an example, FIG. 2 illustrates an additive manufacturing device 15 comprising a chamber 17 inside which there is a substrate 19 to receive successive layers of alloy powder for the manufacture of a part, and a laser 21 to generate a laser beam 23 that can be oriented to direct the laser beam 23 onto a region to be solidified of the last deposited powder layer 25, to form a part 27 resulting from the superimposition of solidified regions of superimposed layers.

In the Direct Metal Deposition technique (DMD) a high energy density laser beam is emitted onto a substrate whilst spraying the alloy powder by means of a spray nozzle coaxial to the laser beam. The alloy powder is heated by the laser beam while it is being conveyed towards the substrate and it is deposited in the form of molten alloy powder on this substrate. The geometry of the part is obtained first by moving the substrate over a plane and secondly by moving the laser beam orthogonally to this plane. The part is then manufactured layer by layer from the design data of this part.

Therefore, at step (b), the alloy powder region is both heated and sprayed onto the substrate.

The Electron Beam Melting technique (EBM) differs from selective laser melting in that it uses a high energy electron beam as heat source to heat and melt the powder.

In one example of embodiment, using electron beam melting, at step (b), the region of alloy powder is heated by an electron beam.

In one example of embodiment, additive manufacturing uses a so-called solid material deposition technique.

In one embodiment, additive manufacturing is performed starting from the copper alloy composition in «solid» form, as opposed to the copper composition in powder form which is able to flow. This is termed additive manufacturing via deposition of material in solid form.

In this case, additive manufacturing is performed for example starting from a wire formed of the copper alloy composition, using an electric arc to melt the wire and to deposit the molten wire at the desired position before it re-solidifies. The superimposition of wires allows the forming of a structure or three-dimensional shape.

In one particular example of embodiment, additive manufacturing is performed by Wire Arc Additive Manufacturing (WAAM).

The method of the invention is preferably conducted in an enclosed chamber i.e. isolated from the outside medium.

In particular, the manufacturing method is preferably conducted in an enclosed chamber under a protective inert gas atmosphere, the mass percentage of oxygen in the atmosphere being less than 10,000 ppm.

This protective atmosphere prevents contamination of the part, in particular by oxygen which could lead to oxidation at the time of manufacture.

The inert gas can be argon for example, nitrogen, helium or other neutral gas, or a mixture of several of these gases.

The chamber and/or manufacturing substrate can be heated to limit residual stresses in the part and deformations of the part on cooling.

The composition of the part produced with said manufacturing method is the composition corresponding to the alloy powder used.

The copper alloy composition allows the manufacture of a part, via an additive manufacturing method, having satisfactory mechanical properties.

1. A copper alloy composition of mass composition Cu_{comp}(Al₂O₃)ₐZr_{b}Cr_{c} in which, in mass percent: 1.5%≤a≤5%, 0.01%≤b≤5%, 0%≤c≤5%, the complement consisting of copper and unavoidable impurities.

2. The copper alloy composition according to claim 1, in the form of a powder.

3. The copper alloy composition according to claim 1, in the form of a solid.

4. A method for manufacturing a copper alloy composition according to claim 1, the method comprising:
providing one or more precursor materials comprising copper alumina and zirconium; and
combining the precursor materials to form the alloy composition.

5. The manufacturing method according to claim 4, wherein the precursor materials are provided in the form of alloy precursor powders, and wherein said combining comprises mechanical mixing of the alloy precursor powders to obtain the copper alloy composition in powder form.

6. The manufacturing method according to claim 5, wherein the alloy precursor powders each have a particle size of between 1 μm and 100 μm.

7. The manufacturing method according to claim 5, wherein the precursor materials are provided in the form of solids, and wherein said combining comprises grinding of the solids.

8. The manufacturing method according to claim 4, wherein said combining comprises:
melting a mixture of precursor materials; and
atomizing under neutral gas the molten mixture to powder particles to obtain the copper alloy composition in powder form.

9. A method for manufacturing a part in copper alloy comprising additive manufacturing by means of a copper alloy composition according to claim 1.

10. The manufacturing method according to claim 9, wherein the copper alloy composition is in powder form and wherein said additive manufacturing comprises melting or sintering particles of the copper alloy composition in powder form by means of a high energy density beam.

11. The manufacturing method according to claim 10, wherein said additive manufacturing comprises implementing, on the copper alloy composition, at least one additive manufacturing technique chosen from among a direct metal deposition technique, a selective laser melting technique, a selective laser sintering technique and electron beam melting.

12. The manufacturing method according to claim 9, comprising:
providing the copper alloy composition in powder form;
heating, by means of the high energy density beam, one portion of the copper alloy composition in powder form;
withdrawing the high energy density beam from the portion of copper alloy composition; and
cooling the portion of copper alloy composition.

13. The manufacturing method according to claim 12, further comprising, prior to said heating, depositing a layer of copper alloy composition in powder form on a substrate, and wherein said heating comprises directing the high energy density beam onto a region of the deposited layer of copper alloy composition in powder form, this region forming the portion of copper alloy composition in powder form.

14. The manufacturing method according to claim 12, wherein said cooling is performed subsequent to said withdrawing.

15. The manufacturing method according to claim 12, wherein said heating, said withdrawing and said cooling are conducted in a heated closed chamber and/or under a protective atmosphere of an inert gas, the mass percentage of oxygen in the atmosphere being less than 10,000 ppm.

16. The manufacturing method according to claim 12, wherein said providing comprises manufacturing a copper alloy composition, comprising:
providing one or more precursor materials comprising copper alumina and zirconium; and
combining the precursor materials to form the alloy composition.

17. The manufacturing method according to claim 9, wherein said additive manufacturing comprises using a deposition of material in solid form from the copper alloy composition in solid form.

18. A part in copper alloy obtained with a manufacturing method according to claim 9, wherein the copper alloy has a mass composition Cu_{comp}(Al₂O₃)ₐZr_{b}Cr_{c} in which, in mass percent: 1.5%≤a≤5%, 0.01%≤b≤5%, 0%≤c≤5%, the complement consisting of copper and unavoidable impurities.

19. The manufacturing method according to claim 16, wherein the precursor materials are provided in the form of alloy precursor powders, and wherein said combining comprises mechanically mixing the alloy precursor powders to obtain the copper alloy composition in powder form.

20. The manufacturing method according to claim 19, wherein the alloy precursor powders each have a particle size of between 1 μm and 100 μm.

21. The manufacturing method according to claim 20, wherein the precursor materials are provided in the form of solids, and wherein said combining comprises grinding of the solids.

22. The manufacturing method according to claim 16, wherein said combining comprises:
melting a mixture of precursor materials; and
atomizing under neutral gas the molten mixture to powder particles to obtain the copper alloy composition in powder form.
